(19) United States
(12) Patent Application Publication
(10) Pub. No.: US 2015/0269064 A1
(43) Pub. Date: Sep. 24, 2015

(54) METHOD AND SYSTEM FOR TESTING CLOUD BASED APPLICATIONS IN A PRODUCTION ENVIRONMENT USING FABRICATED USER DATA

(71) Applicant: Intuit Inc., Mountain View, CA (US)

(72) Inventors: Thomas Bishop, San Diego, CA (US); Javier Godinez, Bonita, CA (US); Capen Brinkley, San Diego, CA (US); Brett Weaver, San Diego, CA (US); M. Shannon Lietz, San Marcos, CA (US); Luis Felipe Cabrera, Bellevue, WA (US)

(73) Assignee: INTUIT INC., Mountain View, CA (US)

(21) Appl. No.: 14/222,279

(22) Filed: Mar. 21, 2014

(51) Int. Cl. G06F 11/36

(52) U.S. Cl. CPC G06F 11/3692; G06F 11/3684

(57) ABSTRACT

An application is implemented in the production environment in which the application will be used. Fabricated user data associated with the application implemented in the production environment is then generated and provided to the application as implemented in the production environment. The fabricated user data is then processed by the application in the production environment to transform the fabricated user data into fabricated user results data. In one embodiment, the fabricated user results data is then analyzed to evaluate the production environment and/or operation of the application in the production environment.

### BACKGROUND

As various forms of distributed computing, such as cloud computing, have come to dominate the computing landscape, security has become a bottleneck issue that currently prevents the complete migration of various capabilities and systems associated with sensitive data, such as financial data, to cloud-based infrastructures, and/or other distributive computing models. This is because many owners and operators of data centers that provide access to data and other resources are extremely hesitant to allow their data and resources to be accessed, processed, and/or otherwise used, by virtual assets in the cloud.

One common mechanism for providing security in a cloud-based computing environment is to deploy an application in a specially designated, and often isolated, testing environment that is distinct from, and often isolated from, the actual production environment in which the application will eventually be run. While testing an application in a designated testing environment can provide a significant amount of information about the security, operation, and reliability of the application, testing environments rarely duplicate the actual production environment in any reasonably realistic way. This is particularly true for Internet facing applications and services.

Herein, the term “production environment” includes the various components actually used to deploy, implement, access, and use, a given application as that application is intended to be used. Consequently, production environments typically include multiple components that are combined, communicatively coupled, and/or associated with each other, to provide the production environment. As specific illustrative examples, the components making up a production environment can include, but are not limited to, one or more computing environments used to implement the application in the production environment such as a data center, a cloud computing environment, and/or one or more other computing environments in which one or more components and/or services used by the application in the production environment are implemented; one or more computing systems used to implement the application in the production environment; one or more virtual assets used to implement the application in the production environment; one or more supervisory or control systems, such as hypervisors, used to implement the application in the production environment; one or more communications channels used to implement the application in the production environment; one or more access control systems, such as firewalls and gateways, used to implement the application in the production environment; one or more routing systems, such as routers and switches, used to implement the application in the production environment; one or more communications endpoint proxy systems, such as load balancers or buffers, used to implement the application in the production environment; one or more traffic and/or access control systems used to implement the application in the production environment; one or more databases used to implement the application in the production environment; one or more services used to implement the application in the production environment; one or more backend servers used to implement the application in the production environment; and/or any other components making up an actual production environment in which an application is to be deployed, implemented, and run, as discussed herein, and/or as known in the art at the time of filing, and/or as developed after the time of filing.

One reason testing environments fail to accurately replicate production environments, and therefore fail to provide a platform to adequately test an application as implemented in a production environment, is that most, if not all, of the components used in a testing environment are not the identical/actual components used in the production environment. In addition, many of the components used in a production environment are simply not present in a testing environment. This is because the cost of providing all of the components that would be present in a production environment in the testing environment is economically prohibitive and inefficient.

Consequently, using current methods for testing applications deployed in production environments, and particularly Internet facing cloud-based implemented applications, often fail to accurately replicate, or even represent, the actual behavior of the applications once deployed in the production environment. Therefore, many applications are currently deployed in production environments without having been thoroughly and accurately tested which, in turn, often means that various security vulnerabilities and operational issues are not discovered until the applications are actually deployed in the production environment. However, particularly in cases of sensitive data, once a security vulnerability is discovered in an actual production environment, it is often too late. That is to say, providing a solution to a security or operational vulnerability in a production environment after that vulnerability has been exploited is often no solution at all because significant damage has been done to user's data, the reputation of the application, and often the reputation of the providers of various components within the production environment.

What is needed is a method and system to accurately test the vulnerabilities and behavior of an application deployed in its actual production environment.

### SUMMARY

In accordance with one embodiment, a method and system for testing cloud based applications in a production environment using fabricated user data includes implementing an application in the production environment in which the application will actually be used and accessed. In one embodiment, fabricated user data associated with the application implemented in the production environment is then generated and provided to the application as implemented in the production environment.

In one embodiment, the fabricated user data is then processed by the application in the production environment to transform the fabricated user data into fabricated user results data. In one embodiment, the fabricated user results data is then analyzed to evaluate the production environment and/or operation of the application in the production environment.

In accordance with one embodiment, a method and system for testing cloud based applications in a production environment using fabricated user data includes implementing an application in the production environment in which the application will be used. In one embodiment, fabricated user data associated with the application implemented in the production environment is then generated. In one embodiment, before actual user data is provided to the application in the production environment, the fabricated user data is provided to the application as implemented in the production environment.

In one embodiment, the fabricated user data is then processed by the application in the production environment to transform the fabricated user data into fabricated user results data. In one embodiment, the fabricated user results data is then analyzed to evaluate the production environment and/or operation of the application in the production environment. In one embodiment, only after a determination is made that the application is functioning properly in the production environment, based, at least in part, on the analysis of the fabricated user results data, is actual user data provided to the application in the production environment.

### BRIEF DESCRIPTION OF THE DRAWINGS

FIG. 1 is a functional block diagram showing the interaction of various elements for implementing one embodiment;

FIG. 2 is a flow chart depicting a process for testing cloud based applications in a production environment using fabricated user data in accordance with one embodiment; and

FIG. 3 is a flow chart depicting a process for testing cloud based applications in a production environment using fabricated user data in accordance with one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

In accordance with one embodiment, a method and system for testing cloud based applications in a production environment using fabricated user data includes a process for testing cloud based applications in a production environment using fabricated user data implemented, at least in part, by one or more computing systems and/or computing entities in a production environment.

Herein, the term “production environment” includes the various components actually used to deploy, implement, access, and use, a given application as that application is intended to be used. In various embodiments, production environments include multiple production environment components that are combined; communicatively coupled; virtually and/or physically connected; and/or associated with one another, to provide the production environment implementing the application.

As specific illustrative examples, the production environment components making up a given production environment can include, but are not limited to, one or more computing environments used to implement the application in the production environment such as a data center, a cloud computing environment, and/or one or more other computing environments in which one or more components and/or services used by the application in the production environment are implemented; one or more computing systems or computing entities used to implement the application in the production environment; one or more virtual assets used to implement the application in the production environment; one or more supervisory or control systems, such as hypervisors, used to implement the application in the production environment; one or more communications channels used to implement the application in the production environment; one or more access control systems, such as firewalls and gateways, used to implement the application in the production environment; one or more routing systems, such as routers and switches, used to implement the application in the production environment; one or more communications endpoint proxy systems, such as load balancers or buffers, used to implement the application in the production environment; one or more traffic or access control systems used to implement the application in the production environment; one or more secure communication protocols and/or endpoints, such as Secure Sockets Layer (SSL) protocols, used to implement the application in the production environment; one or more databases used to implement the application in the production environment; one or more internal or external services used to implement the application in the production environment; one or more backend servers or other hardware used to implement the application in the production environment; one or more software systems used to implement the application in the production environment; and/or any other components making up an actual production environment in which an application is to be deployed, implemented, accessed, and run, as discussed herein, and/or as known in the art at the time of filing, and/or as developed after the time of filing.

As used herein, the terms “computing system” and “computing entity”, include, but are not limited to, a virtual asset; a server computing system; a workstation; a desktop computing system; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple virtual assets; server computing systems; workstations; desktop computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “virtual asset” includes any virtualized entity or resource, and/or part of an actual, or “bare metal” entity. In various embodiments, the virtual assets can be, but are not limited to, virtual machines, virtual servers, and instances implemented in a cloud computing environment; databases implemented, or associated with, a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, ATMs, electronic voting machines, etc., located within a data center, within a cloud computing environment, and/or any other physical or logical location, as discussed herein, and/or as known/available in the art at the time of filing, and/or as developed/made available after the time of filing.

In various embodiments, the one or more computing systems and computing entities included in the production environment and/or implementing the processes for testing cloud based applications in a production environment using fabricated user data are logically or physically located, and/or associated with, two or more computing environments. As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically trusted computing environments are those where the components, infrastructure, communication and networking systems, and security systems associated with the computing systems and/or virtual assets making up the trusted computing environment, are either under the control of, or known to, a party. In contrast, unknown, or untrusted computing environments are environments and systems where the components, infrastructure, communication and networking systems, and security systems implemented and associated with the computing systems and/or virtual assets making up the untrusted computing environment, are not under the control of, and/or are not known by, a party, and/or are dynamically configured with new elements capable of being added that are unknown to the party.

Examples of trusted computing environments include the components making up data centers associated with, and/or controlled by, an application and/or any computing systems and/or virtual assets, and/or networks of computing systems and/or virtual assets, associated with, known by, and/or controlled by, an application. Examples of untrusted computing environments include, but are not limited to, public networks, such as the Internet, various cloud-based computing environments, and various other forms of distributed computing systems.

It is often the case that an application needs to transfer data to, and/or from, a first computing environment that is an untrusted computing environment, such as, but not limited to, a public cloud, a virtual private cloud, and a trusted computing environment, such as, but not limited to, networks of computing systems in a data center controlled by, and/or associated with, the party. However, in other situations a party may wish to transfer data between two trusted computing environments, and/or two untrusted computing environments.

In one embodiment, two or more computing systems and/or virtual assets, and/or two or more computing environments, in the production environment are connected by one or more communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more computing systems and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more computing systems, whether available or known at the time of filing or as later developed.

In one embodiment, the production environment includes one or more cloud computing environments. In various embodiments, the cloud computing environments can be any form of cloud computing environment, such as, but not limited to, a public cloud; a private cloud; a virtual private network (VPN); a subnet; a Virtual Private Cloud, or VPC; a sub-net or any security/communications grouping; or any other cloud-based infrastructure, sub-structure, or architecture, as discussed herein, and/or as known in the art at the time of filing, and/or as developed after the time of filing.

In many cases, a given application or service provided through the production environment may utilize, and interface with, multiple cloud computing environments, such as multiple VPCs, in the course of providing the associated service. In various embodiments, each cloud computing environment includes allocated virtual assets associated with, and controlled or used by, the party utilizing the cloud computing environment.

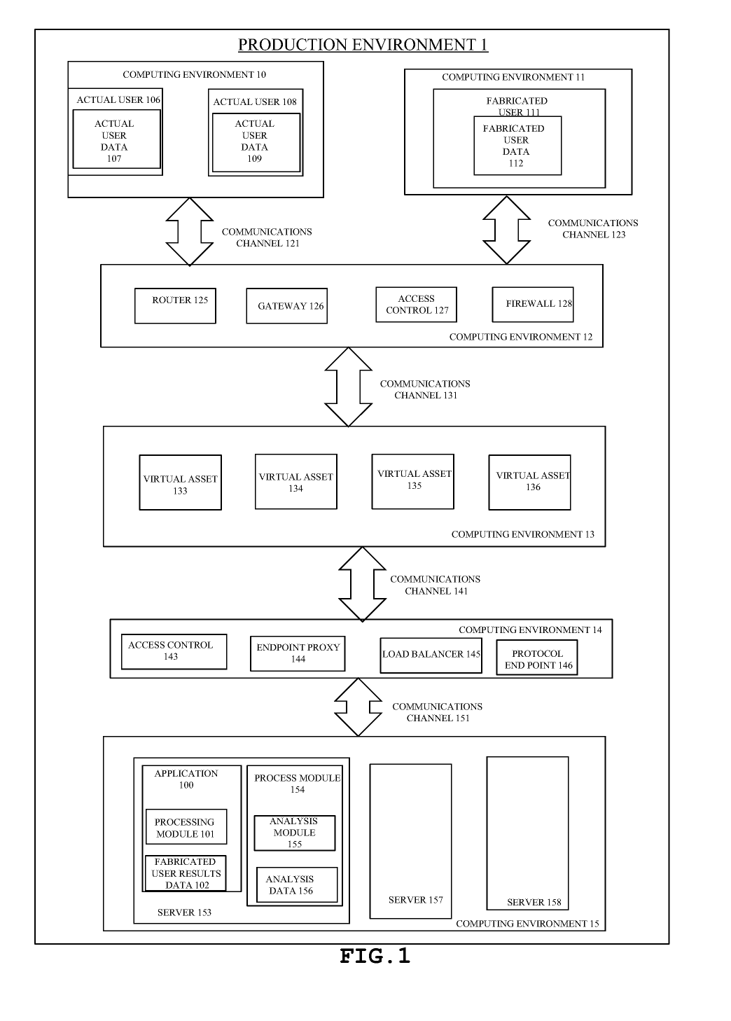

FIG. 1 is a functional diagram of the interaction of various elements associated with exemplary embodiments of the methods and systems for testing cloud based applications in a production environment using fabricated user data discussed herein. Of particular note, the various elements in FIG. 1 are shown for illustrative purposes as being associated with production environment 1 and specific computing environments within production environment 1, such as computing environments 10, 11, 12, 13, 14 and 15. However, the exemplary placement of the various elements within these environments and systems in FIG. 1 is made for illustrative purposes only and, in various embodiments, any individual element shown in FIG. 1, or combination of elements shown in FIG. 1, can be implemented and/or deployed on any of one or more various computing environments or systems, and/or architectural or infrastructure components, such as one or more hardware systems, one or more software systems, one or more data centers, more or more clouds or cloud types, one or more third party service capabilities, or any other computing environments, architectural, and/or infrastructure components, as discussed herein, and/or as known in the art at the time of filing, and/or as developed/made available after the time of filing.

In addition, the elements shown in FIG. 1, and/or the computing environments, systems and architectural and/or infrastructure components, deploying the elements shown in FIG. 1, can be under the control of, or otherwise associated with, various parties or entities, or multiple parties or entities, such as, but not limited to, the owner of a data center, a party and/or entity providing all or a portion of a cloud-based computing environment, the owner or a provider of an application or service, the owner or provider of one or more resources, and/or any other party and/or entity providing one or more functions, and/or any other party and/or entity as discussed herein, and/or as known in the art at the time of filing, and/or as made known after the time of filing.

In accordance with one embodiment, a given application is implemented in the production environment in which the application will be, or is, actually deployed, implemented, accessed, and used, as that application is intended to be used.

Consequently, in one embodiment the application is implemented in the production environment to utilize all of the production environment components that are combined; communicatively coupled; virtually and/or physically connected; and/or associated with one another, to provide the production environment implementing the application.

As specific illustrative examples, the application is implemented using, and including, the actual production environment components such as, but not limited to, the one or more computing environments to actually be used to implement the application in the production environment such as a data center, a cloud computing environment, and/or one or more other computing environments in which one or more components and/or services to actually be used to implement the application in the production environment are implemented; the one or more computing systems or computing entities to actually be used to implement the application in the production environment; the one or more virtual assets to actually be used to implement the application in the production environment; the one or more supervisory or control systems, such as hypervisors, to actually be used to implement the application in the production environment; the one or more communications channels to actually be used to implement the application in the production environment; the one or more access control systems, such as firewalls and gateways, to actually be used to implement the application in the production environment; the one or more routing systems, such as routers and switches, to actually be used to implement the application in the production environment; the one or more communications endpoint proxy systems, such as load balancers or buffers, to actually be used to implement the application in the production environment; the one or more traffic and/or access control systems to actually be used to implement the application in the production environment; the one or more secure communication protocols and/or endpoints, such as Secure Sockets Layer (SSL) protocols, to actually be used to implement the application in the production environment; the one or more databases to actually be used to implement the application in the production environment; the one or more internal or external services to actually be used to implement the application in the production environment; the one or more backend servers or other hardware to actually be used to implement the application in the production environment; the one or more software systems to actually be used to implement the application in the production environment; and/or any other components making up the actual production environment in which an application is to be deployed, implemented, and run, as discussed herein, and/or as known in the art at the time of filing, and/or as developed after the time of filing.

As noted above, FIG. 1 is a functional diagram of the interaction of various elements associated with one embodiment of the methods and systems for testing cloud based applications in a production environment using fabricated user data discussed herein. In particular, FIG. 1 shows application 100 implemented in its production environment 1.

As seen in FIG. 1, in this specific illustrative example, application 100 is implemented using, and including, the actual production environment components such as, but not limited to, the one or more computing environments, e.g., computing environments 10, 11, 12, 13, 14, 15, to actually be used to implement application 100 in production environment 1, such as a data center, a cloud computing environment, and/or one or more other computing environments in which one or more components and/or services to actually be used to implement application 100 in production environment 1 are implemented

As seen in FIG. 1, production environment 1 includes computing environment 10, for instance a local area network, or the Internet, that includes actual users 106 and 108 generating actual user data 107 and 109, respectively, using one or more computing systems. As seen in FIG. 1, actual user data 107 and 109 is provided to computing environment 12, such as an access layer or Internet Service Provider (ISP) service used to access application 100, via communications channel 121.

As seen in FIG. 1, production environment 1 includes computing environment 12 which, in turn, includes, as illustrative examples, one or more of router 125, gateway 126, access control 127, and firewall 128. As seen in FIG. 1, in this specific illustrative example, computing environment 12 is commutatively coupled to computing environment 13 of production environment 1 by communications channel 131.

In the specific illustrative example of FIG. 1, computing environment 13 of production environment 1 is a cloud computing environment and includes various virtual assets 133, 134, 135, and 136 used to implement application 100.

In the specific illustrative example of FIG. 1, production environment 1 includes computing environment 14, such as an access control layer, commutatively coupled to computing environment 13 by communications channel 141. In this specific illustrative example, computing environment 14 includes exemplary access control systems such as one or more of access control 143, endpoint proxy 144, load balancer 145, and protocol endpoint 146.

As seen in the specific illustrative example of FIG. 1, production environment 1 includes computing environment 15, such as a data center or infrastructure provider environment, commutatively coupled to computing environment 14 by communications channel 151. In this specific illustrative example, computing environment 15 includes servers 153, 157 and 158, including server 153 associated with application 100 and a process for testing cloud based applications in a production environment using fabricated user data discussed below.

As noted above, application 100 is implemented in production environment 1 which is the actual production environment in which application 100 will be, or is, actually deployed, implemented, accessed, and used, as application 100 is intended to be used.

In one embodiment, fabricated user data associated with the application is generated.

In one embodiment, the fabricated user data is data similar to actual user data that would be generated by real, or “actual” users and provided to the application for processing. As a specific illustrative example, in the case where the application is a financial management system, the fabricated user data would include data replicating financial data as it would be retrieved from various user accounts associated with an actual user. As another specific illustrative example, in the case where the application is a tax-preparation system, the fabricated user data would include personal and financial data associated with the fictitious, i.e., fabricated, user that is similar to data that would be generated by an actual user.

In one embodiment, the fabricated user data is generated by obtaining actual user data and then processing the actual user data to remove all personal and identification data such as data identifying the actual user, data identifying accounts and access codes associated with the actual user, data indicating a location associated with the actual user data, and/or any other data that is considered sensitive and/or personal to an individual user.

In one embodiment, the fabricated user data is completely fabricated using actual user data models to replicate the form and volume of actual user data.

In various embodiments, the fabricated user data is obtained from any source of fabricated user data, as discussed herein, and/or as known in the art at the time of filing, and/or as developed after the time of filing.

Returning to FIG. 1, in this specific illustrative example, production environment 1 of application 100 includes computing environment 11. As seen in FIG. 1, in one embodiment, computing environment 11 includes fabricated user 111 and fabricated user data 112.

In one embodiment, once the application is implemented in the production environment in which the application will be, or is, actually deployed, implemented, accessed, and used, as that application is intended to be used, and fabricated user data is generated, the fabricated user data is provided to the application in the production environment.

In one embodiment, the fabricated user data is provided to the application in the production environment, even while the application is operating and receiving actual user data in the production environment.

In one embodiment, the fabricated user data is provided to the application in the production environment using a communications channel or data transfer mechanism that is separate from the communications channel used to provide actual user data to the application, but which uses the production environment components provided in the production environment.

In one embodiment, the fabricated user data is then identified and tracked as fabricated user data throughout processing by the application in the production environment of the application.

In one embodiment, the fabricated user data is provided to the application in the production environment using the same communications channel used to provide actual user data to the application in the production environment.

Returning to FIG. 1, in this specific illustrative example, production environment 1 of application 100 includes computing environment 11 commutatively coupled to computing environment 12 by separate communication channel 123 for providing fabricated user data 112 to application 100. As discussed above, in other examples, computing environment 11 is commutatively coupled to computing environment 12 via communication channel 121 for providing fabricated user data 112 to application 100 through the same communication channel used to provide actual user data 107 and 109 to application 100.

In one embodiment, the fabricated user data is tagged and identified throughout processing by the application in the production environment of the application. In one embodiment, the fabricated user data is tagged using headers associated with the fabricated user data and/or data packets making up the fabricated user data.

In one embodiment, the fabricated user data is identified and tracked as it is processed by the application in the production environment and all intermediate processing steps and process transformed data is also identified and tracked as it is processed by the application in the production environment.

Various means, mechanisms, processes, and procedures for identifying and tracking specific data, such as fabricated user data, and intermediate processing steps and process transformed data, are known in the art. Consequently a more detailed discussion of the particular means, mechanisms, processes, and procedures used to identify and track the fabricated user data, and intermediately processed and transformed fabricated user data, is omitted here to avoid detracting from the invention.

In one embodiment, as a result of the processing by the application in the production environment of the fabricated user data, the fabricated user data is transformed into fabricated user results data. That is to say, the fabricated user data is processed by the application in the same manner as any other user data would be processed by the application in the production environment, and using each of the identical and actual production environment components used by the application to process any user data, whether fabricated or actual.

As a specific illustrative example, in the case where the application is a financial management system, the fabricated user data is processed by the application to produce fabricated user results data, in one embodiment, in the form of the one or more specific financial reports generated using the fabricated user data. As another specific illustrative example, in the case where the application is a tax preparation system, the fabricated user data is processed by the application to transform the fabricated user data to produce results data taking the form, in this specific illustrative example, of one or more completed tax filing forms, such as a 1040 tax form.

Returning to FIG. 1, processing module 101 of application 100 directs the operations of application 100 performed on fabricated user data 112 and generates fabricated user results data 102.

In one embodiment, the fabricated user results data and the application operational data, along with the performance/function data for the application in the production environment, is analyzed to evaluate the security and operation/function of the application in the production environment and the security and operation/function of the production environment itself.

Returning to FIG. 1, process module 154 includes analysis module 155 which analyzes fabricated results data 102 and generates analysis data 156 indicating the results of the evaluation of the security and operation/function of application 100 in production environment 1 and the security and operation/function of production environment 1 itself

Using the methods and systems for testing cloud based applications in a production environment using fabricated user data discussed above, an application can be tested using fabricated user data in the actual production environment in which the application is deployed, implemented, accessed, and used.

Consequently, using the methods and systems for testing cloud based applications in a production environment using fabricated user data discussed above, applications can be accurately tested for vulnerabilities and behavior in their actual production environments, and even after they have been deployed and are operating in their production environments; all without risking actual user data. Therefore, the methods and systems for testing cloud based applications in a production environment using fabricated user data discussed above, provide for more secure cloud-based applications, particularly Internet facing cloud-based implemented applications.

In one embodiment, the application is tested in the actual production environment using the fabricated user data prior to providing actual user data to the application in the production environment, and/or prior to enabling various components and capabilities associated with the application in the production environment, i.e., prior to a fully enabled launch of the application in the production environment. As an example, in one embodiment, the application is tested in the actual production environment using the fabricated user data prior to providing Domain Name Service (DNS) servers access to the application.

To this end, in one embodiment, a given application is implemented in the production environment in which the application will be actually deployed, implemented, accessed, and used, as that application is intended to be used.

Consequently, in one embodiment the application is implemented in the production environment to utilize all of the production environment components that are combined; communicatively coupled; virtually and/or physically connected; and/or associated with one another, to provide the production environment implementing the application.

As specific illustrative examples, the application is implemented using, and including, the actual production environment components such as, but not limited to, the one or more computing environments to actually be used to implement the application in the production environment such as a data center, a cloud computing environment, and/or one or more other computing environments in which one or more components and/or services to actually be used to implement the application in the production environment are implemented; the one or more computing systems or computing entities to actually be used to implement the application in the production environment; the one or more virtual assets to actually be used to implement the application in the production environment; the one or more supervisory or control systems, such as hypervisors, to actually be used to implement the application in the production environment; the one or more communications channels to actually be used to implement the application in the production environment; the one or more access control systems, such as firewalls and gateways, to actually be used to implement the application in the production environment; the one or more routing systems, such as routers and switches, to actually be used to implement the application in the production environment; the one or more communications endpoint proxy systems, such as load balancers or buffers, to actually be used to implement the application in the production environment; the one or more traffic and/or access control systems to actually be used to implement the application in the production environment; the one or more secure communication protocols and/or endpoints, such as Secure Sockets Layer (SSL) protocols, to actually be used to implement the application in the production environment; the one or more databases to actually be used to implement the application in the production environment; the one or more internal or external services to actually be used to implement the application in the production environment; the one or more backend servers or other hardware to actually be used to implement the application in the production environment; the one or more software systems to actually be used to implement the application in the production environment; and/or any other components making up the actual production environment in which an application is to be deployed, implemented, and run, as discussed herein, and/or as known in the art at the time of filing, and/or as developed after the time of filing.

In one embodiment, fabricated user data associated with the application is generated.

In one embodiment, the fabricated user data is data similar to actual user data that would be generated by real, or “actual” users and provided to the application for processing. As a specific illustrative example, in the case where the application is a financial management system, the fabricated user data would include data replicating financial data as it would be retrieved from various user accounts associated with an actual user. As another specific illustrative example, in the case where the application is a tax-preparation system, the fabricated user data would include personal and financial data associated with the fictitious, i.e., fabricated, user that is similar to data that would be generated by an actual user.

In one embodiment, the fabricated user data is generated by obtaining actual user data and then processing the actual user data to remove all personal and identification data such as data identifying the actual user, data identifying accounts and access codes associated with the actual user, data indicating a location associated with the actual user data, and/or any other data that is considered sensitive and/or personal to an individual user.

In one embodiment, the fabricated user data is completely fabricated using actual user data models to replicate the form and volume of actual user data.

In various embodiments, the fabricated user data is obtained from any source of fabricated user data, as discussed herein, and/or as known in the art at the time of filing, and/or as developed after the time of filing.

In one embodiment, once the application is implemented in the production environment in which the application will actually be deployed, implemented, accessed, and used, as that application is intended to be used, and fabricated user data is generated, but before actual user data is provided to the application, and/or prior to enabling various components and capabilities associated with the application in the production environment, the fabricated user data is provided to the application in the production environment.

As noted, in one embodiment, the fabricated user data is provided to the application in the production environment before actual user data is provided to the application, and/or prior to enabling various components and capabilities associated with the application in the production environment.

In one embodiment, the fabricated user data is provided to the application in the production environment, before actual user data is provided to the application, and/or prior to enabling various components and capabilities associated with the application in the production environment, using a communications channel or data transfer mechanism that is separate from the communications channel used to provide actual user data to the application, but which uses the production environment components provided in the production environment.

In one embodiment, the fabricated user data is provided to the application in the production environment, but before actual user data is provided to the application, and/or prior to enabling various components and capabilities associated with the application in the production environment, using the same communications channel used to provide actual user data to the application in the production environment.

In one embodiment, as a result of the processing by the application in the production environment of the fabricated user data, the fabricated user data is transformed into fabricated user results data. That is to say, the fabricated user data is processed by the application in the same manner as any other user data would be processed by the application in the production environment, and using each of the identical and actual production environment components used by the application to process any user data, whether fabricated or actual.

As a specific illustrative example, in the case where the application is a financial management system, the fabricated user data is processed by the application to produce fabricated user results data, in one embodiment, in the form of the one or more specific financial reports generated using the fabricated user data. As another specific illustrative example, in the case where the application is a tax preparation system, the fabricated user data is processed by the application to transform the fabricated user data to produce results data taking the form, in this specific illustrative example, of one or more completed tax filing forms, such as a 1040 tax form.

In one embodiment, the fabricated user results data and the application operational data, along with the performance/function data for the application in the production environment, is analyzed to evaluate the security and operation/function of the application in the production environment and the security and operation/function of the production environment itself.

In one embodiment, once the fabricated user results data is analyzed, if a determination is made that the application is operating satisfactorily in the production environment, then, and only then, is actual user data provided to the application, and/or various components and capabilities associated with the application in the production environment are enabled, and the application is fully implemented or launched in the production environment for use by actual users.

Using the methods and systems for testing cloud based applications in a production environment using fabricated user data discussed above, an application can be tested using fabricated user data in the actual production environment in which the application is to be deployed, implemented, accessed, and used, prior to providing actual data, and/or full application capabilities, to the application.

Consequently, using the methods and systems for testing cloud based applications in a production environment using fabricated user data discussed above, applications can be accurately tested for vulnerabilities and behavior in their actual production environments, prior to providing actual data, and/or full application capabilities, to the application, and without risking actual user data. Therefore, the methods and systems for testing cloud based applications in a production environment using fabricated user data discussed above, provide for more secure cloud-based applications, particularly Internet facing cloud-based implemented applications.

### Process

In accordance with one embodiment, a method and system for testing cloud based applications in a production environment using fabricated user data includes implementing an application in the production environment in which the application will actually be used and accessed. In one embodiment, fabricated user data associated with the application implemented in the production environment is then generated and provided to the application as implemented in the production environment.

In one embodiment, the fabricated user data is then processed by the application in the production environment to transform the fabricated user data into fabricated user results data. In one embodiment, the fabricated user results data is then analyzed to evaluate the production environment and/or operation of the application in the production environment.

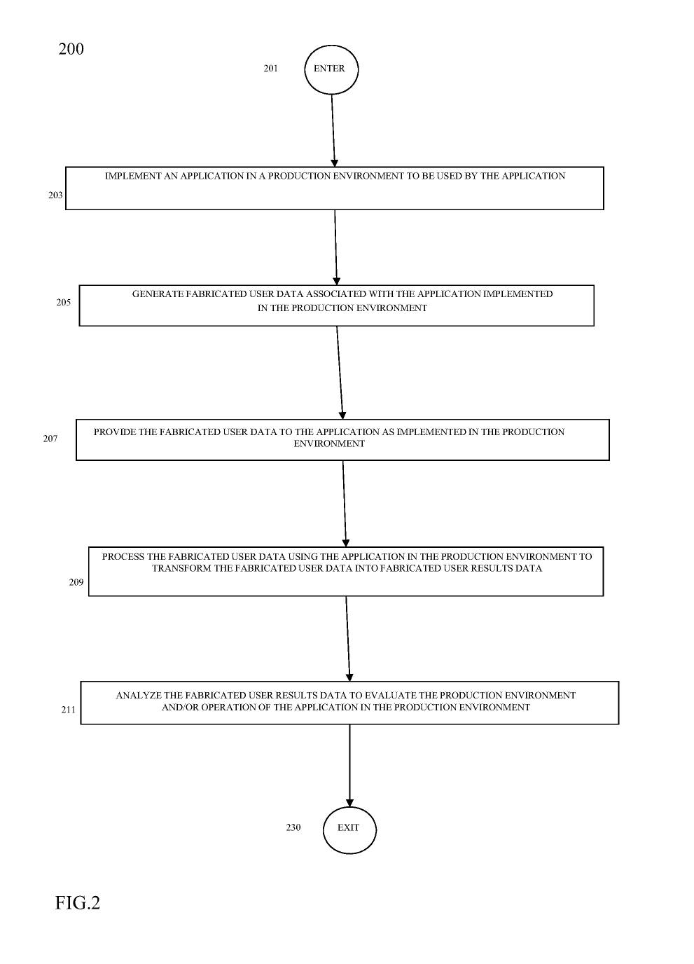

FIG. 2 is a flow chart of a process 200 for testing cloud based applications in a production environment using fabricated user data in accordance with one embodiment. In one embodiment, process 200 for testing cloud based applications in a production environment using fabricated user data begins at ENTER OPERATION 201 of FIG. 2 and process flow proceeds to IMPLEMENT AN APPLICATION IN A PRODUCTION ENVIRONMENT TO BE USED BY THE APPLICATION OPERATION 203.

In one embodiment, at IMPLEMENT AN APPLICATION IN A PRODUCTION ENVIRONMENT TO BE USED BY THE APPLICATION OPERATION 203 a given application is implemented in the production environment in which the application will be, or is, actually deployed, implemented, accessed, and used, as that application is intended to be used.

In one embodiment, the application is implemented at IMPLEMENT AN APPLICATION IN A PRODUCTION ENVIRONMENT TO BE USED BY THE APPLICATION OPERATION 203 in the production environment to utilize all of the production environment components that are combined; communicatively coupled; virtually and/or physically connected; and/or associated with one another, to provide the production environment implementing the application.

As specific illustrative examples, in one embodiment, at IMPLEMENT AN APPLICATION IN A PRODUCTION ENVIRONMENT TO BE USED BY THE APPLICATION OPERATION 203 the application is implemented using, and including, the actual production environment components such as, but not limited to, the one or more computing environments to actually be used to implement the application in the production environment such as a data center, a cloud computing environment, and/or one or more other computing environments in which one or more components and/or services to actually be used to implement the application in the production environment are implemented; the one or more computing systems or computing entities to actually be used to implement the application in the production environment; the one or more virtual assets to actually be used to implement the application in the production environment; the one or more supervisory or control systems, such as hypervisors, to actually be used to implement the application in the production environment; the one or more communications channels to actually be used to implement the application in the production environment; the one or more access control systems, such as firewalls and gateways, to actually be used to implement the application in the production environment; the one or more routing systems, such as routers and switches, to actually be used to implement the application in the production environment; the one or more communications endpoint proxy systems, such as load balancers or buffers, to actually be used to implement the application in the production environment; the one or more access control systems to actually be used to implement the application in the production environment; the one or more secure communication protocols and/or endpoints, such as Secure Sockets Layer (SSL) protocols, to actually be used to implement the application in the production environment; the one or more databases to actually be used to implement the application in the production environment; the one or more internal or external services to actually be used to implement the application in the production environment; the one or more backend servers or other hardware to actually be used to implement the application in the production environment; the one or more software systems to actually be used to implement the application in the production environment; and/or any other components making up the actual production environment in which an application is to be deployed, implemented, and run, as discussed herein, and/or as known in the art at the time of filing, and/or as developed after the time of filing.

In one embodiment, once the application is implemented in the production environment in which the application will be, or is, actually deployed, implemented, accessed, and used, as that application is intended to be used at IMPLEMENT AN APPLICATION IN A PRODUCTION ENVIRONMENT TO BE USED BY THE APPLICATION OPERATION 203, process flow proceeds to GENERATE FABRICATED USER DATA ASSOCIATED WITH THE APPLICATION IMPLEMENTED IN THE PRODUCTION ENVIRONMENT OPERATION 205.

In one embodiment, at GENERATE FABRICATED USER DATA ASSOCIATED WITH THE APPLICATION IMPLEMENTED IN THE PRODUCTION ENVIRONMENT OPERATION 205, fabricated user data associated with the application is generated.

In one embodiment, the fabricated user data of GENERATE FABRICATED USER DATA ASSOCIATED WITH THE APPLICATION IMPLEMENTED IN THE PRODUCTION ENVIRONMENT OPERATION 205 is data similar to actual user data that would be generated by real, or “actual” users and provided to the application for processing.

As a specific illustrative example, in the case where the application of IMPLEMENT AN APPLICATION IN A PRODUCTION ENVIRONMENT TO BE USED BY THE APPLICATION OPERATION 203 is a financial management system, the fabricated user data would include data replicating financial data as it would be retrieved from various user accounts associated with an actual user.

As another specific illustrative example, in the case where the application of IMPLEMENT AN APPLICATION IN A PRODUCTION ENVIRONMENT TO BE USED BY THE APPLICATION OPERATION 203 is a tax-preparation system, the fabricated user data would include personal and financial data associated with the fictitious, i.e., fabricated, user that is similar to data that would be generated by an actual user.

In one embodiment, the fabricated user data is generated at GENERATE FABRICATED USER DATA ASSOCIATED WITH THE APPLICATION IMPLEMENTED IN THE PRODUCTION ENVIRONMENT OPERATION 205 by obtaining actual user data and then processing the actual user data to remove all personal and identification data such as data identifying the actual user, data identifying accounts and access codes associated with the actual user, data indicating a location associated with the actual user data, and/or any other data that is considered sensitive and/or personal to an individual user.

In one embodiment, the fabricated user data of GENERATE FABRICATED USER DATA ASSOCIATED WITH THE APPLICATION IMPLEMENTED IN THE PRODUCTION ENVIRONMENT OPERATION 205 is completely fabricated using actual user data models to replicate the form and volume of actual user data.

In various embodiments, the fabricated user data is obtained at GENERATE FABRICATED USER DATA ASSOCIATED WITH THE APPLICATION IMPLEMENTED IN THE PRODUCTION ENVIRONMENT OPERATION 205 from any source of fabricated user data, as discussed herein, and/or as known in the art at the time of filing, and/or as developed after the time of filing.

In one embodiment, once fabricated user data associated with the application is generated at GENERATE FABRICATED USER DATA ASSOCIATED WITH THE APPLICATION IMPLEMENTED IN THE PRODUCTION ENVIRONMENT OPERATION 205, process flow proceeds to PROVIDE THE FABRICATED USER DATA TO THE APPLICATION AS IMPLEMENTED IN THE PRODUCTION ENVIRONMENT OPERATION 207.

In one embodiment, once the application is implemented in the production environment in which the application will be, or is, actually deployed, implemented, accessed, and used, as that application is intended to be used at IMPLEMENT AN APPLICATION IN A PRODUCTION ENVIRONMENT TO BE USED BY THE APPLICATION OPERATION 203, and fabricated user data is generated at GENERATE FABRICATED USER DATA ASSOCIATED WITH THE APPLICATION IMPLEMENTED IN THE PRODUCTION ENVIRONMENT OPERATION 205, the fabricated user data is provided to the application in the production environment at PROVIDE THE FABRICATED USER DATA TO THE APPLICATION AS IMPLEMENTED IN THE PRODUCTION ENVIRONMENT OPERATION 207.

In one embodiment, the fabricated user data of GENERATE FABRICATED USER DATA ASSOCIATED WITH THE APPLICATION IMPLEMENTED IN THE PRODUCTION ENVIRONMENT OPERATION 205 is provided to the application in the production environment at PROVIDE THE FABRICATED USER DATA TO THE APPLICATION AS IMPLEMENTED IN THE PRODUCTION ENVIRONMENT OPERATION 207 using a communications channel or data transfer mechanism that is separate from the communications channel used to provide actual user data to the application, but which uses each of the production environment components provided in the production environment.

As discussed below, in one embodiment, the fabricated user data is then identified and tracked as fabricated user data throughout processing by the application in the production environment of the application.

In one embodiment, the fabricated user data of GENERATE FABRICATED USER DATA ASSOCIATED WITH THE APPLICATION IMPLEMENTED IN THE PRODUCTION ENVIRONMENT OPERATION 205 is provided to the application in the production environment at PROVIDE THE FABRICATED USER DATA TO THE APPLICATION AS IMPLEMENTED IN THE PRODUCTION ENVIRONMENT OPERATION 207 using the same communications channel used to provide actual user data to the application in the production environment.

As discussed below, in one embodiment, the fabricated user data is tagged and identified throughout processing by the application in the production environment of the application. In one embodiment, the fabricated user data is tagged using headers associated with the fabricated user data and/or data packets making up the fabricated user data.

In one embodiment, once the fabricated user data is provided to the application in the production environment at PROVIDE THE FABRICATED USER DATA TO THE APPLICATION AS IMPLEMENTED IN THE PRODUCTION ENVIRONMENT OPERATION 207, process flow proceeds to PROCESS THE FABRICATED USER DATA USING THE APPLICATION IN THE PRODUCTION ENVIRONMENT TO TRANSFORM THE FABRICATED USER DATA INTO FABRICATED USER RESULTS DATA OPERATION 209.

In one embodiment, at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA OPERATION 209 the fabricated user data of PROVIDE THE FABRICATED USER DATA TO THE APPLICATION AS IMPLEMENTED IN THE PRODUCTION ENVIRONMENT OPERATION 207 is processed by the application in the actual production environment to transform the fabricated user data into fabricated user results data.

In one embodiment, at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA OPERATION 209 the fabricated user data is identified and tracked as fabricated user data throughout processing by the application in the production environment of the application.

In one embodiment, at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA OPERATION 209 the fabricated user data is tagged and identified throughout processing by the application in the production environment of the application. In one embodiment, the fabricated user data is tagged at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA OPERATION 209 using headers associated with the fabricated user data and/or data packets making up the fabricated user data.

In one embodiment, the fabricated user data is identified and tracked at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA OPERATION 209 as it is processed by the application in the production environment and all intermediate processing steps and process transformed data is also identified and tracked as it is processed by the application in the production environment.

Various means, mechanisms, processes, and procedures for identifying and tracking specific data, such as fabricated user data, and intermediate processing steps and process transformed data, are known in the art. Consequently a more detailed discussion of the particular means, mechanisms, processes, and procedures used to identify and track the fabricated user data, and intermediately processed and transformed fabricated user data, is omitted here to avoid detracting from the invention.

In one embodiment, as a result of the processing by the application of the fabricated user data in the production environment, the fabricated user data is transformed into fabricated user results data at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA OPERATION 209. That is to say, at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA OPERATION 209 the fabricated user data is processed by the application in the same manner as any other user data would be processed by the application in the production environment, and using each of the identical and actual production environment components used by the application to process any user data, whether fabricated or actual.

As a specific illustrative example, in the case where the application of IMPLEMENT AN APPLICATION IN A PRODUCTION ENVIRONMENT TO BE USED BY THE APPLICATION OPERATION 203 is a financial management system, the fabricated user data of GENERATE FABRICATED USER DATA ASSOCIATED WITH THE APPLICATION IMPLEMENTED IN THE PRODUCTION ENVIRONMENT OPERATION 205 is processed by the application at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA OPERATION 209 to produce fabricated user results data, in one embodiment, in the form of the one or more specific financial reports generated using the fabricated user data.

As another specific illustrative example, in the case where the application of IMPLEMENT AN APPLICATION IN A PRODUCTION ENVIRONMENT TO BE USED BY THE APPLICATION OPERATION 203 is a tax preparation system, the fabricated user data of GENERATE FABRICATED USER DATA ASSOCIATED WITH THE APPLICATION IMPLEMENTED IN THE PRODUCTION ENVIRONMENT OPERATION 205 is processed by the application at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA OPERATION 209 to produce results data taking the form, in this specific illustrative example, of one or more completed tax filing forms, such as a 1040 tax form.

In one embodiment, once the fabricated user data of PROVIDE THE FABRICATED USER DATA TO THE APPLICATION AS IMPLEMENTED IN THE PRODUCTION ENVIRONMENT OPERATION 207 is processed by the application in the actual production environment to transform the fabricated user data into fabricated user results data at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA OPERATION 209, process flow proceeds to ANALYZE THE FABRICATED USER RESULTS DATA TO EVALUATE THE PRODUCTION ENVIRONMENT AND/OR OPERATION OF THE APPLICATION IN THE PRODUCTION ENVIRONMENT OPERATION 211.

In one embodiment, at ANALYZE THE FABRICATED USER RESULTS DATA TO EVALUATE THE PRODUCTION ENVIRONMENT AND/OR OPERATION OF THE APPLICATION IN THE PRODUCTION ENVIRONMENT OPERATION 211 the fabricated user results data of PROCESS THE FABRICATED USER DATA USING THE APPLICATION IN THE PRODUCTION ENVIRONMENT TO TRANSFORM THE FABRICATED USER DATA INTO FABRICATED USER RESULTS DATA OPERATION 209 and the application operational data, along with the performance/function data for the application in the production environment of IMPLEMENT AN APPLICATION IN A PRODUCTION ENVIRONMENT TO BE USED BY THE APPLICATION OPERATION 203, is analyzed to evaluate the security and operation/function of the application of IMPLEMENT AN APPLICATION IN A PRODUCTION ENVIRONMENT TO BE USED BY THE APPLICATION OPERATION 203 in the production environment and the security and operation/function of the production environment itself.

In one embodiment, once the fabricated user results data and the application operational data, along with the performance/function data for the application in the production environment, is analyzed to evaluate the security and operation/function of the application in the production environment and the security and operation/function of the production environment itself at ANALYZE THE FABRICATED USER RESULTS DATA TO EVALUATE THE PRODUCTION ENVIRONMENT AND/OR OPERATION OF THE APPLICATION IN THE PRODUCTION ENVIRONMENT OPERATION 211, process flow proceeds to EXIT OPERATION 230.

In one embodiment, at EXIT OPERATION 230 process 200 for testing cloud based applications in a production environment using fabricated user data is exited to await new data.

Using process 200 for testing cloud based applications in a production environment using fabricated user data, an application can be tested using fabricated user data in the actual production environment in which the application is deployed, implemented, accessed, and used.

Consequently, using process 200 for testing cloud based applications in a production environment using fabricated user data, applications can be accurately tested for vulnerabilities and behavior in their actual production environments, and even after they have been deployed and are operating in their production environments; all without risking actual user data. Therefore, process 200 for testing cloud based applications in a production environment using fabricated user data provides for more secure cloud-based applications, particularly Internet facing cloud-based implemented applications.

In one embodiment, the application is tested in the actual production environment using the fabricated user data prior to providing actual user data to the application in the production environment, and/or prior to enabling various components and capabilities associated with the application in the production environment, i.e., prior to a fully enabled launch of the application in the production environment. As an example, in one embodiment, the application is tested in the actual production environment using the fabricated user data prior to providing Domain Name Service (DNS) servers access to the application.

In accordance with one embodiment, a method and system for testing cloud based applications in a production environment using fabricated user data includes implementing an application in the production environment in which the application will be used. In one embodiment, fabricated user data associated with the application implemented in the production environment is then generated. In one embodiment, before actual user data is provided to the application in the production environment, the fabricated user data is provided to the application as implemented in the production environment.

In one embodiment, the fabricated user data is then processed by the application in the production environment to transform the fabricated user data into fabricated user results data. In one embodiment, the fabricated user results data is then analyzed to evaluate the production environment and/or operation of the application in the production environment. In one embodiment, only after a determination is made that the application is functioning properly in the production environment, based, at least in part, on the analysis of the fabricated user results data, is actual user data provided to the application in the production environment.

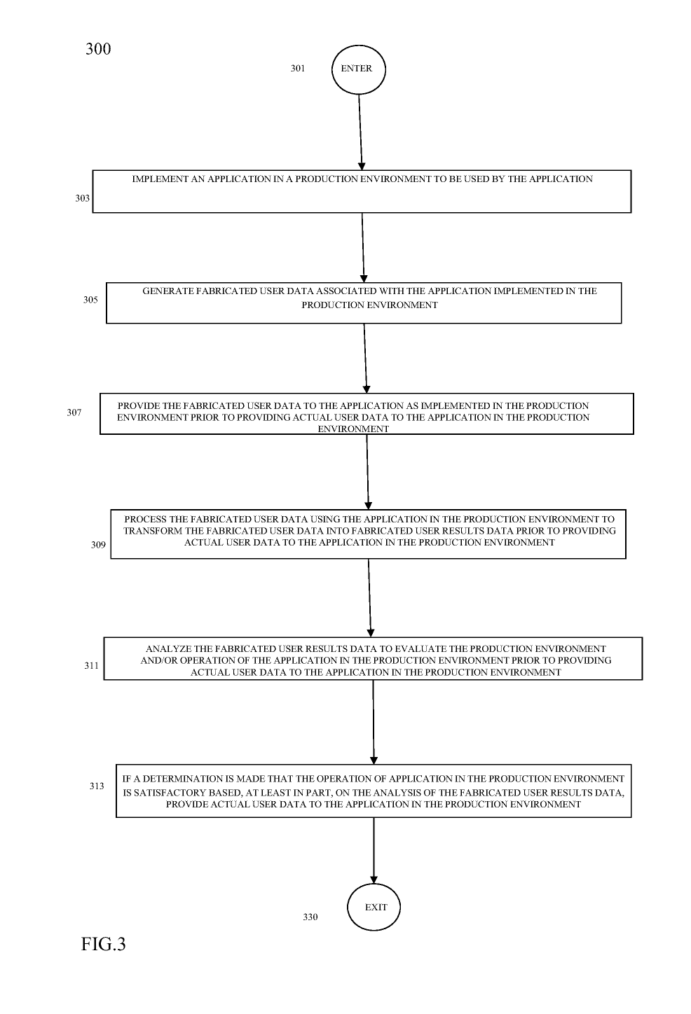

FIG. 3 is a flow chart of a process 300 for testing cloud based applications in a production environment using fabricated user data in accordance with one embodiment. In one embodiment, process 300 for testing cloud based applications in a production environment using fabricated user data begins at ENTER OPERATION 301 of FIG. 3 and process flow proceeds to IMPLEMENT AN APPLICATION IN A PRODUCTION ENVIRONMENT TO BE USED BY THE APPLICATION OPERATION 303.

In one embodiment, at IMPLEMENT AN APPLICATION IN A PRODUCTION ENVIRONMENT TO BE USED BY THE APPLICATION OPERATION 303 a given application is implemented in the production environment in which the application will be actually deployed, implemented, accessed, and used, as that application is intended to be used.

In one embodiment the application is implemented in the production environment at IMPLEMENT AN APPLICATION IN A PRODUCTION ENVIRONMENT TO BE USED BY THE APPLICATION OPERATION 303 to utilize all of the production environment components that are combined; communicatively coupled; virtually and/or physically connected; and/or associated with one another, to provide the production environment implementing the application.

As specific illustrative examples, the application is implemented at IMPLEMENT AN APPLICATION IN A PRODUCTION ENVIRONMENT TO BE USED BY THE APPLICATION OPERATION 303 using, and including, the actual production environment components such as, but not limited to, the one or more computing environments to actually be used to implement the application in the production environment such as a data center, a cloud computing environment, and/or one or more other computing environments in which one or more components and/or services to actually be used to implement the application in the production environment are implemented; the one or more computing systems or computing entities to actually be used to implement the application in the production environment; the one or more virtual assets to actually be used to implement the application in the production environment; the one or more supervisory or control systems, such as hypervisors, to actually be used to implement the application in the production environment; the one or more communications channels to actually be used to implement the application in the production environment; the one or more access control systems, such as firewalls and gateways, to actually be used to implement the application in the production environment; the one or more routing systems, such as routers and switches, to actually be used to implement the application in the production environment; the one or more communications endpoint proxy systems, such as load balancers or buffers, to actually be used to implement the application in the production environment; the one or more traffic and/or access control systems to actually be used to implement the application in the production environment; the one or more secure communication protocols and/or endpoints, such as Secure Sockets Layer (SSL) protocols, to actually be used to implement the application in the production environment; the one or more databases to actually be used to implement the application in the production environment; the one or more internal or external services to actually be used to implement the application in the production environment; the one or more backend servers or other hardware to actually be used to implement the application in the production environment; the one or more software systems to actually be used to implement the application in the production environment; and/or any other components making up the actual production environment in which an application is to be deployed, implemented, and run, as discussed herein, and/or as known in the art at the time of filing, and/or as developed after the time of filing.

In one embodiment, once a given application is implemented in the production environment in which the application will be actually deployed, implemented, accessed, and used, as that application is intended to be used at IMPLEMENT AN APPLICATION IN A PRODUCTION ENVIRONMENT TO BE USED BY THE APPLICATION OPERATION 303, process flow proceeds to GENERATE FABRICATED USER DATA ASSOCIATED WITH THE APPLICATION IMPLEMENTED IN THE PRODUCTION ENVIRONMENT OPERATION 305.

In one embodiment, at GENERATE FABRICATED USER DATA ASSOCIATED WITH THE APPLICATION IMPLEMENTED IN THE PRODUCTION ENVIRONMENT OPERATION 305 fabricated user data associated with the application is generated.

In one embodiment, the fabricated user data of GENERATE FABRICATED USER DATA ASSOCIATED WITH THE APPLICATION IMPLEMENTED IN THE PRODUCTION ENVIRONMENT OPERATION 305 is data similar to actual user data that would be generated by real, or “actual” users and provided to the application for processing.

As a specific illustrative example, in the case where the application of IMPLEMENT AN APPLICATION IN A PRODUCTION ENVIRONMENT TO BE USED BY THE APPLICATION OPERATION 303 is a financial management system, the fabricated user data of GENERATE FABRICATED USER DATA ASSOCIATED WITH THE APPLICATION IMPLEMENTED IN THE PRODUCTION ENVIRONMENT OPERATION 305 would include data replicating financial data as it would be retrieved from various user accounts associated with an actual user.

As another specific illustrative example, in the case where the application of IMPLEMENT AN APPLICATION IN A PRODUCTION ENVIRONMENT TO BE USED BY THE APPLICATION OPERATION 303 is a tax-preparation system, the fabricated user data of GENERATE FABRICATED USER DATA ASSOCIATED WITH THE APPLICATION IMPLEMENTED IN THE PRODUCTION ENVIRONMENT OPERATION 305 would include personal and financial data associated with the fictitious, i.e., fabricated, user that is similar to data that would be generated by an actual user.

In one embodiment, the fabricated user data is generated at GENERATE FABRICATED USER DATA ASSOCIATED WITH THE APPLICATION IMPLEMENTED IN THE PRODUCTION ENVIRONMENT OPERATION 305 by obtaining actual user data and then processing the actual user data to remove all personal and identification data such as data identifying the actual user, data identifying accounts and access codes associated with the actual user, data indicating a location associated with the actual user data, and/or any other data that is considered sensitive and/or personal to an individual user.

In one embodiment, the fabricated user data is completely fabricated at GENERATE FABRICATED USER DATA ASSOCIATED WITH THE APPLICATION IMPLEMENTED IN THE PRODUCTION ENVIRONMENT OPERATION 305 using actual user data models to replicate the form and volume of actual user data.

In various embodiments, the fabricated user data is obtained at GENERATE FABRICATED USER DATA ASSOCIATED WITH THE APPLICATION IMPLEMENTED IN THE PRODUCTION ENVIRONMENT OPERATION 305 from any source of fabricated user data, as discussed herein, and/or as known in the art at the time of filing, and/or as developed after the time of filing.

In one embodiment, once fabricated user data associated with the application is generated at GENERATE FABRICATED USER DATA ASSOCIATED WITH THE APPLICATION IMPLEMENTED IN THE PRODUCTION ENVIRONMENT OPERATION 305, process flow proceeds to PROVIDE THE FABRICATED USER DATA TO THE APPLICATION AS IMPLEMENTED IN THE PRODUCTION ENVIRONMENT PRIOR TO PROVIDING ACTUAL USER DATA TO THE APPLICATION IN THE PRODUCTION ENVIRONMENT OPERATION 307.

In one embodiment, once the application is implemented in the production environment in which the application will actually be deployed, implemented, accessed, and used, as that application is intended to be used at IMPLEMENT AN APPLICATION IN A PRODUCTION ENVIRONMENT TO BE USED BY THE APPLICATION OPERATION 303, and fabricated user data is generated at GENERATE FABRICATED USER DATA ASSOCIATED WITH THE APPLICATION IMPLEMENTED IN THE PRODUCTION ENVIRONMENT OPERATION 305, but before actual user data is provided to the application, and/or prior to enabling various components and capabilities associated with the application in the production environment, the fabricated user data is provided to the application in the production environment at PROVIDE THE FABRICATED USER DATA TO THE APPLICATION AS IMPLEMENTED IN THE PRODUCTION ENVIRONMENT PRIOR TO PROVIDING ACTUAL USER DATA TO THE APPLICATION IN THE PRODUCTION ENVIRONMENT OPERATION 307.

As noted, in one embodiment, at PROVIDE THE FABRICATED USER DATA TO THE APPLICATION AS IMPLEMENTED IN THE PRODUCTION ENVIRONMENT PRIOR TO PROVIDING ACTUAL USER DATA TO THE APPLICATION IN THE PRODUCTION ENVIRONMENT OPERATION 307, the fabricated user data is provided to the application in the production environment before actual user data is provided to the application, and/or prior to enabling various components and capabilities associated with the application in the production environment.

In one embodiment, the fabricated user data is provided to the application in the production environment, before actual user data is provided to the application, and/or prior to enabling various components and capabilities associated with the application in the production environment at PROVIDE THE FABRICATED USER DATA TO THE APPLICATION AS IMPLEMENTED IN THE PRODUCTION ENVIRONMENT PRIOR TO PROVIDING ACTUAL USER DATA TO THE APPLICATION IN THE PRODUCTION ENVIRONMENT OPERATION 307, using a communications channel or data transfer mechanism that is separate from the communications channel used to provide actual user data to the application, but which uses each of the production environment components provided in the production environment of IMPLEMENT AN APPLICATION IN A PRODUCTION ENVIRONMENT TO BE USED BY THE APPLICATION OPERATION 303.

In one embodiment, at PROVIDE THE FABRICATED USER DATA TO THE APPLICATION AS IMPLEMENTED IN THE PRODUCTION ENVIRONMENT PRIOR TO PROVIDING ACTUAL USER DATA TO THE APPLICATION IN THE PRODUCTION ENVIRONMENT OPERATION 307 the fabricated user data is provided to the application in the production environment, before actual user data is provided to the application, and/or prior to enabling various components and capabilities associated with the application in the production environment, using the same communications channel used to provide actual user data to the application in the production environment.

In one embodiment, once the fabricated user data is provided to the application in the production environment before actual user data is provided to the application, and/or prior to enabling various components and capabilities associated with the application in the production environment, at PROVIDE THE FABRICATED USER DATA TO THE APPLICATION AS IMPLEMENTED IN THE PRODUCTION ENVIRONMENT PRIOR TO PROVIDING ACTUAL USER DATA TO THE APPLICATION IN THE PRODUCTION ENVIRONMENT OPERATION 307, process flow proceeds to PROCESS THE FABRICATED USER DATA USING THE APPLICATION IN THE PRODUCTION ENVIRONMENT TO TRANSFORM THE FABRICATED USER DATA INTO FABRICATED USER RESULTS DATA PRIOR TO PROVIDING ACTUAL USER DATA TO THE APPLICATION IN THE PRODUCTION ENVIRONMENT OPERATION 309.

In one embodiment, at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA PRIOR TO PROVIDING ACTUAL USER DATA TO THE APPLICATION IN THE PRODUCTION ENVIRONMENT OPERATION 309 the fabricated user data of PROVIDE THE FABRICATED USER DATA TO THE APPLICATION AS IMPLEMENTED IN THE PRODUCTION ENVIRONMENT PRIOR TO PROVIDING ACTUAL USER DATA TO THE APPLICATION IN THE PRODUCTION ENVIRONMENT OPERATION 307 is processed by the application of IMPLEMENT AN APPLICATION IN A PRODUCTION ENVIRONMENT TO BE USED BY THE APPLICATION OPERATION 303 in the actual production environment to transform the fabricated user data into fabricated user results data.

In one embodiment, as a result of the processing by the application in the production environment of the fabricated user data at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA PRIOR TO PROVIDING ACTUAL USER DATA TO THE APPLICATION IN THE PRODUCTION ENVIRONMENT OPERATION 309, the fabricated user data is transformed into fabricated user results data. That is to say, the fabricated user data is processed by the application in the same manner at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA PRIOR TO PROVIDING ACTUAL USER DATA TO THE APPLICATION IN THE PRODUCTION ENVIRONMENT OPERATION 309 as any other user data would be processed by the application in the production environment, and using each of the identical and actual production environment components used by the application to process any user data, whether fabricated or actual, before actual user data is provided to the application, and/or prior to enabling various components and capabilities associated with the application in the production environment.

As a specific illustrative example, in the case where the application of IMPLEMENT AN APPLICATION IN A PRODUCTION ENVIRONMENT TO BE USED BY THE APPLICATION OPERATION 303 is a financial management system, the fabricated user data of PROVIDE THE FABRICATED USER DATA TO THE APPLICATION AS IMPLEMENTED IN THE PRODUCTION ENVIRONMENT PRIOR TO PROVIDING ACTUAL USER DATA TO THE APPLICATION IN THE PRODUCTION ENVIRONMENT OPERATION 307 is processed by the application at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA PRIOR TO PROVIDING ACTUAL USER DATA TO THE APPLICATION IN THE PRODUCTION ENVIRONMENT OPERATION 309 to produce fabricated user results data, in one embodiment, in the form of the one or more specific financial reports generated using the fabricated user data.

As another specific illustrative example, in the case where the application of IMPLEMENT AN APPLICATION IN A PRODUCTION ENVIRONMENT TO BE USED BY THE APPLICATION OPERATION 303 is a tax preparation system, the fabricated user data of PROVIDE THE FABRICATED USER DATA TO THE APPLICATION AS IMPLEMENTED IN THE PRODUCTION ENVIRONMENT PRIOR TO PROVIDING ACTUAL USER DATA TO THE APPLICATION IN THE PRODUCTION ENVIRONMENT OPERATION 307 is processed by the application at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA PRIOR TO PROVIDING ACTUAL USER DATA TO THE APPLICATION IN THE PRODUCTION ENVIRONMENT OPERATION 309 to transform the fabricated user data to produce results data taking the form, in this specific illustrative example, of one or more completed tax filing forms, such as a 1040 tax form.

In one embodiment, once the fabricated user data of PROVIDE THE FABRICATED USER DATA TO THE APPLICATION AS IMPLEMENTED IN THE PRODUCTION ENVIRONMENT PRIOR TO PROVIDING ACTUAL USER DATA TO THE APPLICATION IN THE PRODUCTION ENVIRONMENT OPERATION 307 is processed by the application of IMPLEMENT AN APPLICATION IN A PRODUCTION ENVIRONMENT TO BE USED BY THE APPLICATION OPERATION 303 in the actual production environment to transform the fabricated user data into fabricated user results data at PROCESS THE FABRICATED USER DATA USING THE APPLICATION IN THE PRODUCTION ENVIRONMENT TO TRANSFORM THE FABRICATED USER DATA INTO FABRICATED USER RESULTS DATA PRIOR TO PROVIDING ACTUAL USER DATA TO THE APPLICATION IN THE PRODUCTION ENVIRONMENT OPERATION 309 process flow proceeds to ANALYZE THE FABRICATED USER RESULTS DATA TO EVALUATE THE PRODUCTION ENVIRONMENT AND/OR OPERATION OF THE APPLICATION IN THE PRODUCTION ENVIRONMENT PRIOR TO PROVIDING ACTUAL USER DATA TO THE APPLICATION IN THE PRODUCTION ENVIRONMENT OPERATION 311.

In one embodiment, at ANALYZE THE FABRICATED USER RESULTS DATA TO EVALUATE THE PRODUCTION ENVIRONMENT AND/OR OPERATION OF THE APPLICATION IN THE PRODUCTION ENVIRONMENT PRIOR TO PROVIDING ACTUAL USER DATA TO THE APPLICATION IN THE PRODUCTION ENVIRONMENT OPERATION 311, the fabricated user results data and the application operational data, along with the performance/function data for the application in the production environment, of PROCESS THE FABRICATED USER DATA USING THE APPLICATION IN THE PRODUCTION ENVIRONMENT TO TRANSFORM THE FABRICATED USER DATA INTO FABRICATED USER RESULTS DATA PRIOR TO PROVIDING ACTUAL USER DATA TO THE APPLICATION IN THE PRODUCTION ENVIRONMENT OPERATION 309 is analyzed to evaluate the security and operation/function of the application in the production environment and the security and operation/function of the production environment itself.

In one embodiment, once the fabricated user results data of PROCESS THE FABRICATED USER DATA USING THE APPLICATION IN THE PRODUCTION ENVIRONMENT TO TRANSFORM THE FABRICATED USER DATA INTO FABRICATED USER RESULTS DATA PRIOR TO PROVIDING ACTUAL USER DATA TO THE APPLICATION IN THE PRODUCTION ENVIRONMENT OPERATION 309 and the application operational data, along with the performance/function data for the application in the production environment of IMPLEMENT AN APPLICATION IN A PRODUCTION ENVIRONMENT TO BE USED BY THE APPLICATION OPERATION 303, is analyzed to evaluate the security and operation/function of the application of IMPLEMENT AN APPLICATION IN A PRODUCTION ENVIRONMENT TO BE USED BY THE APPLICATION OPERATION 303 in the production environment and the security and operation/function of the production environment itself at ANALYZE THE FABRICATED USER RESULTS DATA TO EVALUATE THE PRODUCTION ENVIRONMENT AND/OR OPERATION OF THE APPLICATION IN THE PRODUCTION ENVIRONMENT PRIOR TO PROVIDING ACTUAL USER DATA TO THE APPLICATION IN THE PRODUCTION ENVIRONMENT OPERATION 311, process flow proceeds to IF A DETERMINATION IS MADE THAT THE OPERATION OF APPLICATION IN THE PRODUCTION ENVIRONMENT IS SATISFACTORY BASED, AT LEAST IN PART, ON THE ANALYSIS OF THE FABRICATED USER RESULTS DATA, PROVIDE ACTUAL USER DATA TO THE APPLICATION IN THE PRODUCTION ENVIRONMENT OPERATION 313.

In one embodiment, once the fabricated user results data is analyzed at ANALYZE THE FABRICATED USER RESULTS DATA TO EVALUATE THE PRODUCTION ENVIRONMENT AND/OR OPERATION OF THE APPLICATION IN THE PRODUCTION ENVIRONMENT PRIOR TO PROVIDING ACTUAL USER DATA TO THE APPLICATION IN THE PRODUCTION ENVIRONMENT OPERATION 311, if a determination is made that the application is operating satisfactorily in the production environment, then, at IF A DETERMINATION IS MADE THAT THE OPERATION OF APPLICATION IN THE PRODUCTION ENVIRONMENT IS SATISFACTORY BASED, AT LEAST IN PART, ON THE ANALYSIS OF THE FABRICATED USER RESULTS DATA, PROVIDE ACTUAL USER DATA TO THE APPLICATION IN THE PRODUCTION ENVIRONMENT OPERATION 313 actual user data is provided to the application, and/or various components and capabilities associated with the application in the production environment are enabled, and the application of IMPLEMENT AN APPLICATION IN A PRODUCTION ENVIRONMENT TO BE USED BY THE APPLICATION OPERATION 303 is fully implemented or launched in the production environment for use by actual users.

In one embodiment, once the fabricated user results data is analyzed, a determination is made that the application is operating satisfactorily in the production environment, actual user data is provided to the application, and/or various components and capabilities associated with the application in the production environment are enabled, i.e., the application of IMPLEMENT AN APPLICATION IN A PRODUCTION ENVIRONMENT TO BE USED BY THE APPLICATION OPERATION 303 is fully implemented or launched in the production environment for use by actual users at IF A DETERMINATION IS MADE THAT THE OPERATION OF APPLICATION IN THE PRODUCTION ENVIRONMENT IS SATISFACTORY BASED, AT LEAST IN PART, ON THE ANALYSIS OF THE FABRICATED USER RESULTS DATA, PROVIDE ACTUAL USER DATA TO THE APPLICATION IN THE PRODUCTION ENVIRONMENT OPERATION 313, process flow proceeds to EXIT OPERATION 330.

In one embodiment, at EXIT OPERATION 330 process 300 for testing cloud based applications in a production environment using fabricated user data is exited to await new data.

Using process 300 for testing cloud based applications in a production environment using fabricated user data, an application can be tested using fabricated user data in the actual production environment in which the application is to be deployed, implemented, accessed, and used, prior to providing actual data, and/or full application capabilities, to the application.

Consequently, using process 300 for testing cloud based applications in a production environment using fabricated user data, applications can be accurately tested for vulnerabilities and behavior in their actual production environments, prior to providing actual data, and/or full application capabilities, to the application, and without risking actual user data. Therefore, process 300 for testing cloud based applications in a production environment using fabricated user data provides for more secure cloud-based applications, particularly Internet facing cloud-based implemented applications.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature often used in the art to identify equivalent operations.

Therefore, numerous variations, whether explicitly provided for by the specification or implied by the specification or not, may be implemented by one of skill in the art in view of this disclosure.

What is claimed is:

1. A system for testing cloud based applications in a production environment using fabricated user data:
at least one processor; and
at least one memory coupled to the at least one processor, the at least one memory having stored therein instructions which when executed by any set of the one or more processors, perform a process for testing cloud based applications in a production environment using fabricated user data, the process for testing cloud based applications in a production environment using fabricated user data including:
implementing an application in a production environment;
generating fabricated user data associated with the application implemented in the production environment;
providing the fabricated user data to the application as implemented in the production environment;
processing the fabricated user data using the application in the production environment to transform the fabricated user data into fabricated user results data; and
analyzing the fabricated user results data to evaluate the production environment and/or operation of the application in the production environment.

2. The system for testing cloud based applications in a production environment using fabricated user data of claim 1 wherein the production environment includes one or more production environment components selected from the group of production environment components consisting of:
one or more computing environments used to implement the application in the production environment;
one or more computing systems used to implement the application in the production environment;
one or more virtual assets used to implement the application in the production environment;
one or more hypervisors used to implement the application in the production environment;
one or more communications channels used to implement the application in the production environment;
one or more firewalls used to implement the application in the production environment;
one or more routers used to implement the application in the production environment;
one or more communications endpoint proxy systems used to implement the application in the production environment;
one or more access control systems used to implement the application in the production environment;
one or more load balancers used to implement the application in the production environment;
one or more databases used to implement the application in the production environment;
one or more services used to implement the application in the production environment; and
one or more backend servers used to implement the application in the production environment.

3. The system for testing cloud based applications in a production environment using fabricated user data of claim 2 wherein at least one of the one or more computing environments used to implement the application in the production environment is a cloud-based computing environment.

4. The system for testing cloud based applications in a production environment using fabricated user data of claim 2 wherein at least one of the one or more virtual assets used to implement the application in the production environment is selected from the group of the virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

5. The system for testing cloud based applications in a production environment using fabricated user data of claim 2 wherein at least one of the one or more computing environments used to implement the application in the production environment is a cloud-based computing environment and at least one of the one or more backend servers used to implement the application in the production environment are backend servers implemented in a computing environment that is distinct from the cloud-based computing environment.

6. The system for testing cloud based applications in a production environment using fabricated user data of claim 5 wherein at least one of the one or more backend servers are implemented in a data center associated with the application.

7. The system for testing cloud based applications in a production environment using fabricated user data of claim 1 wherein the fabricated user data associated with the application implemented in the production environment is modified actual user data obtained from the application.

8. The system for testing cloud based applications in a production environment using fabricated user data of claim 7 wherein the fabricated user data associated with the application implemented in the production environment is actual user data modified to any remove user identification data identifying the user or any accounts associated with the user.

9. The system for testing cloud based applications in a production environment using fabricated user data of claim 1 the fabricated user data is provided to the application as implemented in the production environment using a separate communications channel.

10. The system for testing cloud based applications in a production environment using fabricated user data of claim 1 wherein the fabricated user data is provided to the application as implemented in the production environment using the same communications channel used to transfer actual user data.

11. The system for testing cloud based applications in a production environment using fabricated user data of claim 10 wherein the fabricated user data is tagged as fabricated user data.

12. The system for testing cloud based applications in a production environment using fabricated user data of claim 10 wherein the fabricated user data is identified as fabricated user data in the header data of the fabricated user data.

13. A system for testing cloud based applications in a production environment using fabricated user data:
at least one processor; and
at least one memory coupled to the at least one processor, the at least one memory having stored therein instructions which when executed by any set of the one or more processors, perform a process for testing cloud based applications in a production environment using fabricated user data, the process for testing cloud based applications in a production environment using fabricated user data including:
implementing an application in a production environment;
generating fabricated user data associated with the application implemented in the production environment;
providing the fabricated user data to the application as implemented in the production environment prior to providing actual user data to the application;
processing the fabricated user data using the application in the production environment to transform the fabricated user data into fabricated user results data;
analyzing the fabricated user results data to evaluate the production environment and/or operation of the application in the production environment;
providing the application actual user data only after a determination is made that the operation of application in the production environment is satisfactory based, at least in part, on the analysis of the fabricated user results data.

14. The system for testing cloud based applications in a production environment using fabricated user data of claim 13 wherein the production environment includes one or more production environment components selected from the group of production environment components consisting of:
one or more computing environments used to implement the application in the production environment;
one or more computing systems used to implement the application in the production environment;
one or more virtual assets used to implement the application in the production environment;
one or more hypervisors used to implement the application in the production environment;
one or more communications channels used to implement the application in the production environment;
one or more firewalls used to implement the application in the production environment;
one or more routers used to implement the application in the production environment;
one or more communications endpoint proxy systems used to implement the application in the production environment;
one or more access control systems used to implement the application in the production environment;
one or more load balancers used to implement the application in the production environment;
one or more databases used to implement the application in the production environment;
one or more services used to implement the application in the production environment; and
one or more backend servers used to implement the application in the production environment.

15. The system for testing cloud based applications in a production environment using fabricated user data of claim 14 wherein at least one of the one or more computing environments used to implement the application in the production environment is a cloud-based computing environment.

16. The system for testing cloud based applications in a production environment using fabricated user data of claim 14 wherein at least one of the one or more virtual assets used to implement the application in the production environment is selected from the group of the virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

17. The system for testing cloud based applications in a production environment using fabricated user data of claim 14 wherein at least one of the one or more computing environments used to implement the application in the production environment is a cloud-based computing environment and at least one of the one or more backend servers used to implement the application in the production environment are backend servers implemented in a computing environment that is distinct from the cloud-based computing environment.

18. The system for testing cloud based applications in a production environment using fabricated user data of claim 17 wherein at least one of the one or more backend servers are implemented in a data center associated with the application.

19. The system for testing cloud based applications in a production environment using fabricated user data of claim 13 wherein the fabricated user data associated with the application implemented in the production environment is modified actual user data.

20. The system for testing cloud based applications in a production environment using fabricated user data of claim 19 wherein the fabricated user data associated with the application implemented in the production environment is actual user data modified to any remove user identification data identifying the user or any accounts associated with the user.

21. A system for testing cloud based applications in a production environment using fabricated user data:
a production environment;
an application implemented in the production environment;
fabricated user data associated with the application implemented in the production environment;
at least one processor; and
at least one memory coupled to the at least one processor, the at least one memory having stored therein instructions which when executed by any set of the one or more processors, perform a process for testing cloud based applications in a production environment using fabricated user data, the process for testing cloud based applications in a production environment using fabricated user data including:
providing the fabricated user data to the application implemented in the production environment;
processing the fabricated user data using the application in the production environment to transform the fabricated user data into fabricated user results data; and
analyzing the fabricated user results data to evaluate the production environment and/or operation of the application in the production environment.

22. The system for testing cloud based applications in a production environment using fabricated user data of claim 21 wherein the production environment includes one or more production environment components selected from the group of production environment components consisting of:
one or more computing environments used to implement the application in the production environment;
one or more computing systems used to implement the application in the production environment;
one or more virtual assets used to implement the application in the production environment;
one or more hypervisors used to implement the application in the production environment;
one or more communications channels used to implement the application in the production environment;
one or more firewalls used to implement the application in the production environment;
one or more routers used to implement the application in the production environment;
one or more communications endpoint proxy systems used to implement the application in the production environment;
one or more access control systems used to implement the application in the production environment;
one or more load balancers used to implement the application in the production environment;
one or more databases used to implement the application in the production environment;
one or more services used to implement the application in the production environment; and
one or more backend servers used to implement the application in the production environment.

23. The system for testing cloud based applications in a production environment using fabricated user data of claim 22 wherein at least one of the one or more computing environments used to implement the application in the production environment is a cloud-based computing environment.

24. The system for testing cloud based applications in a production environment using fabricated user data of claim 22 wherein at least one of the one or more virtual assets used to implement the application in the production environment is selected from the group of the virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

25. The system for testing cloud based applications in a production environment using fabricated user data of claim 22 wherein at least one of the one or more computing environments used to implement the application in the production environment is a cloud-based computing environment and at least one of the one or more backend servers used to implement the application in the production environment are backend servers implemented in a computing environment that is distinct from the cloud-based computing environment.

26. The system for testing cloud based applications in a production environment using fabricated user data of claim 25 wherein at least one of the one or more backend servers are implemented in a data center associated with the application.

27. The system for testing cloud based applications in a production environment using fabricated user data of claim 21 wherein the fabricated user data associated with the application implemented in the production environment is modified actual user data obtained from the application.

28. The system for testing cloud based applications in a production environment using fabricated user data of claim 27 wherein the fabricated user data associated with the application implemented in the production environment is actual user data modified to any remove user identification data identifying the user or any accounts associated with the user.

29. The system for testing cloud based applications in a production environment using fabricated user data of claim 21 the fabricated user data is provided to the application as implemented in the production environment using a separate communications channel.

30. The system for testing cloud based applications in a production environment using fabricated user data of claim 21 wherein the fabricated user data is provided to the application as implemented in the production environment using the same communications channel used to transfer actual user data.

31. The system for testing cloud based applications in a production environment using fabricated user data of claim 30 wherein the fabricated user data is tagged as fabricated user data.

32. The system for testing cloud based applications in a production environment using fabricated user data of claim 30 wherein the fabricated user data is identified as fabricated user data in the header data of the fabricated user data.

33. A system for testing cloud based applications in a production environment using fabricated user data:
a production environment;
an application implemented in the production environment;
fabricated user data associated with the application implemented in the production environment;
at least one processor; and
at least one memory coupled to the at least one processor, the at least one memory having stored therein instructions which when executed by any set of the one or more processors, perform a process for testing cloud based applications in a production environment using fabricated user data, the process for testing cloud based applications in a production environment using fabricated user data including:
implementing an application in a production environment;
generating fabricated user data associated with the application implemented in the production environment;
providing the fabricated user data to the application as implemented in the production environment prior to providing actual user data to the application;
processing the fabricated user data using the application in the production environment to transform the fabricated user data into fabricated user results data;
analyzing the fabricated user results data to evaluate the production environment and/or operation of the application in the production environment;
providing the application actual user data only after a determination is made that the operation of application in the production environment is satisfactory based, at least in part, on the analysis of the fabricated user results data.

34. The system for testing cloud based applications in a production environment using fabricated user data of claim 33 wherein the production environment includes one or more production environment components selected from the group of production environment components consisting of:
one or more computing environments used to implement the application in the production environment;
one or more computing systems used to implement the application in the production environment;
one or more virtual assets used to implement the application in the production environment;
one or more hypervisors used to implement the application in the production environment;
one or more communications channels used to implement the application in the production environment;
one or more firewalls used to implement the application in the production environment;
one or more routers used to implement the application in the production environment;
one or more communications endpoint proxy systems used to implement the application in the production environment;
one or more access control systems used to implement the application in the production environment;
one or more load balancers used to implement the application in the production environment;
one or more databases used to implement the application in the production environment;
one or more services used to implement the application in the production environment; and
one or more backend servers used to implement the application in the production environment.

35. The system for testing cloud based applications in a production environment using fabricated user data of claim 34 wherein at least one of the one or more computing environments used to implement the application in the production environment is a cloud-based computing environment.

36. The system for testing cloud based applications in a production environment using fabricated user data of claim 34 wherein at least one of the one or more virtual assets used to implement the application in the production environment is selected from the group of the virtual assets consisting of:
a virtual machine;
a virtual server;
a database or data store;
an instance in a cloud environment;
a cloud environment access system;
part of a mobile device;
part of a remote sensor;
part of a server computing system; and
part of a desktop computing system.

37. The system for testing cloud based applications in a production environment using fabricated user data of claim 34 wherein at least one of the one or more computing environments used to implement the application in the production environment is a cloud-based computing environment and at least one of the one or more backend servers used to implement the application in the production environment are backend servers implemented in a computing environment that is distinct from the cloud-based computing environment.

38. The system for testing cloud based applications in a production environment using fabricated user data of claim 37 wherein at least one of the one or more backend servers are implemented in a data center associated with the application.

39. The system for testing cloud based applications in a production environment using fabricated user data of claim 33 wherein the fabricated user data associated with the application implemented in the production environment is modified actual user data.

40. The system for testing cloud based applications in a production environment using fabricated user data of claim 39 wherein the fabricated user data associated with the application implemented in the production environment is actual user data modified to any remove user identification data identifying the user or any accounts associated with the user.
